(19) United States
(12) Patent Application Publication
(10) Pub. No.: US 2007/0033369 A1
(43) Pub. Date: Feb. 8, 2007

(54) Reconfigurable integrated circuit device

(75) Inventors: Ichiro Kasama, Kawasaki (JP); Toru Tsuruta, Kawasaki (JP); Masaru Nishida, Fukuoka (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/340,871

(22) Filed: Jan. 27, 2006

(30) Foreign Application Priority Data
Aug. 2, 2005 (JP) 2005-224208

(51) Int. Cl. G06F 12/00

(52) U.S. Cl. 711/170

(57) ABSTRACT

A reconfigurable integrated circuit device which is dynamically constructed to be an arbitrary operation status based on a configuration data, has a plurality of clusters including operation processor elements, a memory processor element, and an inter-processor element switch group for connecting the elements in an arbitrary status; an inter-cluster switch group for constructing data paths between the clusters in an arbitrary status; and an external memory bus. A direct memory access control section, for executing the data transfer between the memory processor element and the external memory by direct memory access responding to an access request from the memory processor elements of the plurality of clusters, is further provided.

### CROSS-REFERENCE TO RELATED APPLICATIONS

This application is based upon and claims the benefit of priority from the prior Japanese Patent Application No. 2005-224208, filed on Aug. 02, 2005, the entire contents of which are incorporated herein by reference.

### BACKGROUND OF THE INVENTION

1. Field of the Invention

The present invention relates to a reconfigurable integrated circuit device, and more particularly to a novel configuration of an internal memory which is installed in a reconfigurable integrated circuit device for performing data transfer with an external memory.

2. Description of the Related Art

A reconfigurable integrated circuit device includes a plurality of processor elements and a network for inter-connecting these processor elements, wherein a sequencer provides configuration data to the processor elements and the network responding to an external or internal event, and configures an arbitrary operation status or operation circuit by the processor elements and the network according to this configuration data. A conventional programmable microprocessor sequentially reads instructions stored in a memory, and sequentially processes them. Since the number of instructions to be executed simultaneously by one processor is limited, the microprocessor has a certain limit in its processing capability.

In the case of the reconfigurable integrated circuit device recently proposed, on the other hand, an ALU having the functions of an adder, multiplier, comparator and a plurality of types of processor elements such as a delay circuit and counter are installed in advance, and a network for connecting these processor elements is installed, then the plurality of processor elements and the network are reconfigured in a desired configuration by the configuration data from a status transition control section having a sequencer, and a predetermined operation is executed in the operation status. When data processing in one operation status completes, another operation status is constructed by another configuration data, and different data processing is performed in that status.

By dynamically constructing different operation statuses in this way, the data processing capability for a large volume of data can be improved, and the general processing efficiency can be increased. Such a reconfigurable integrated circuit device is disclosed in Japanese Patent Application Laid-Open No. 2001-312481, for example.

### SUMMARY OF THE INVENTION

In the case of a conventional reconfigurable integrated circuit device, the arrays of a plurality of processor elements are surrounded by switches which connect between the processors, and the status transition control section supplies configuration data to the processor elements and the switch group to set an arbitrary operation status. In the processor element group, data is input from an external memory, the processor element group, which is set to the operation status, executes a predetermined data processing on the input data, and data acquired by this is output.

In the above mentioned integrated circuit device, data required for data processing is read from the external memory in batch and is stored in an internal memory, then the processor element group, which is set to a certain operation status, and the switch group perform data processing for all the data which was read.

However a reconfigurable integrated circuit device executes different applications by a predetermined number of processor elements which are dynamically configured. Therefore each processor element is demanded to read or write a required volume of data to/from the external memory at a required timing. In the case of prior art, data is transferred via the data paths using the switch group connecting the processor elements, and data can be transferred with the external memory only at a predetermined timing.

Also a predetermined number of internal memories, for storing data read from the external memory or data to be written to the external memory, are installed for the plurality of processor elements, but the operation status to be configured by the user varies, and it is difficult to estimate how many internal memories are required and what kind of input/output characteristics the internal memories require. Therefore in the reconfigurable integrated circuit device, high flexibility is demanded in the configuration and operation of the internal memory.

With the foregoing in view, it is an object of the present invention to provide a reconfigurable integrated circuit device which allows a highly flexible configuration and operation of the internal memory.

To achieve this object, a first aspect of the present invention is a reconfigurable integrated circuit device which is dynamically constructed to be an arbitrary operation status based on a configuration data, comprising: a plurality of clusters including a plurality of operation processor elements having a computing element respectively, a memory processor element having a memory to perform data transfer with an external memory, and an inter-processor element switch group for connecting the operation processor elements and the memory processor element in an arbitrary status; an inter-cluster switch group for constructing data paths between the clusters in an arbitrary status; and an external memory bus for performing data transfer between the memory processor element and the external memory, wherein the operation processor elements, memory processor element, inter-processor element switch group, and inter-cluster switch group are dynamically changed based on the configuration data, and a direct memory access control section, for executing the data transfer between the memory processor element and the external memory by direct memory access responding to an access request from the memory processor elements of the plurality of clusters, is further provided.

According to the first aspect, the memory processor element installed in the cluster can perform data transfer with the external memory by direct memory access via an external memory bus which is different from the inter-cluster switch group, and a reconfigured operation can be executed for the data in the external memory at a timing appropriate for the reconfigured operation status.

In the first aspect of the present invention, it is preferable that the cluster further comprises a configuration data memory for storing the configuration data, and a sequencer for outputting the configuration data to construct the next operation status from the configuration data memory responding to an end signal from the operation processor element and the memory processor element.

In the first aspect it is preferable that the reconfigurable integrated circuit device further comprises a data flow control section, which is installed as a common for the plurality of memory processor elements, for accepting direct memory access requests from the plurality of memory processor elements, and for instructing synchronized direct memory access requests to the direct memory access control section for the plurality of memory processor elements. By this data flow control section, access requests from the plurality of memory processor elements can be synchronously executed.

In the first aspect the memory processor element further comprises an internal side interface with an internal bus which is connected to the inter-processor element switch group and an external interface with the external memory bus, wherein the memory processor element is accessed by the operation processor element via the internal side interface while the memory processor element is accessing the external memory by direct memory access via the external side interface. According to this aspect, data transfer can be performed seamlessly between the external memory and the operation processor elements.

In the first aspect, it is also preferable that the memory processor element accepts data transfer with the operation processor element while performing data transfer with the external memory by direct memory access, asserts a stall signal to stop the operation of the plurality of operation processor elements when the data transfer by direct memory access cannot follow up the data transfer with the operation processor element, and negates the stall signal when follow up is possible. According to this aspect, when a seamless data transfer cannot be performed between the external memory and the operation processor elements, the operation of the operation processor elements can be stopped to prevent malfunction.

To achieve the above object, a second aspect of the present invention is a reconfigurable integrated circuit device, which is dynamically configured to be a predetermined operation status based on a configuration data, comprising: a plurality of clusters including an operation processor element having a computing element, a memory processor element having a memory to perform data transfer with an external memory, and an inter-processor element switch group for connecting the operation processor element and the memory processor element in an arbitrary status; an inter-cluster switch group for constructing data paths between the clusters in an arbitrary status; and an external memory bus for performing data transfer between the memory processor element and the external memory, wherein the operation processor element, memory processor element, inter-processor element switch group and inter-cluster switch group are dynamically changed based on the configuration data, and a direct memory access control section, for executing the data transfer between the memory processor element and the external memory by direct memory access responding to the access request from the memory processor elements of the plurality of clusters, is further provided, and the memory processor element further comprises first and second memory banks, wherein while one of the first and second memory banks is performing data transfer with the external memory by direct memory access, the other of the first and second memory banks performs data transfer with the operation processor element.

According to the second aspect, seamless data transfer can be performed between the external memory and the operation processor element via an external memory bus, which is different from the inter-cluster switch group at an arbitrary timing.

According to the present invention, the memory processor element installed in each cluster enables data transfer by direct memory access to the external memory separately from the data path between the clusters, so the flexibility of data transfer to the memory processor element in the reconfigurable integrated circuit device is increased, and data transfer can be performed efficiently.

### BRIEF DESCRIPTION OF THE DRAWINGS

FIG. 1 is a block diagram depicting a cluster constituting a part of the reconfigurable integrated circuit device according to the present embodiment;

FIG. 2 is a diagram depicting a configuration example of the PE network section according to the present embodiment;

FIG. 3 is a diagram depicting a configuration example of a circuit which is configured by the configuration data of the PE network section according to the present embodiment;

FIG. 4 is a diagram depicting a configuration example of a circuit which is configured by the configuration data of the PE network section according to the present embodiment;

FIG. 5 is a block diagram depicting the reconfigurable integrated circuit device according to the present embodiment;

FIG. 6 is a block diagram depicting an example of the memory processor element according to the present embodiment;

FIG. 7 are diagrams depicting the switching operation of the two memory banks in the memory processor element according to the present embodiment;

FIG. 8 are diagrams depicting the switching operation of the two memory banks in the memory processor element according to the present embodiment;

FIG. 9 are diagrams depicting the switching operation of the two memory banks in the memory processor element according to the present embodiment;

FIG. 10 are diagrams depicting the switching operation of the two memory banks in the memory processor element according to the present embodiment;

FIG. 11 are diagrams depicting the switching operation of the two memory banks in the memory processor element according to the present embodiment;

FIG. 12 is a block diagram depicting the control section of the memory processor element according to the present embodiment;

FIG. 13 is a status transition diagram of the control section of the memory processor element according to the present embodiment;

FIG. 14 are diagrams depicting the flag change control of the access end register;

FIG. 15 are diagrams depicting the external side interface in the memory PE; and

FIG. 16 are diagrams depicting the external side interface in the memory PE.

### DESCRIPTION OF THE PREFERRED EMBODIMENTS

Embodiments of the present invention will now be described with reference to the drawings. The technical scope of the present invention, however, shall not be limited to these embodiments, but extend to the matters stated in the claims and equivalents thereof.

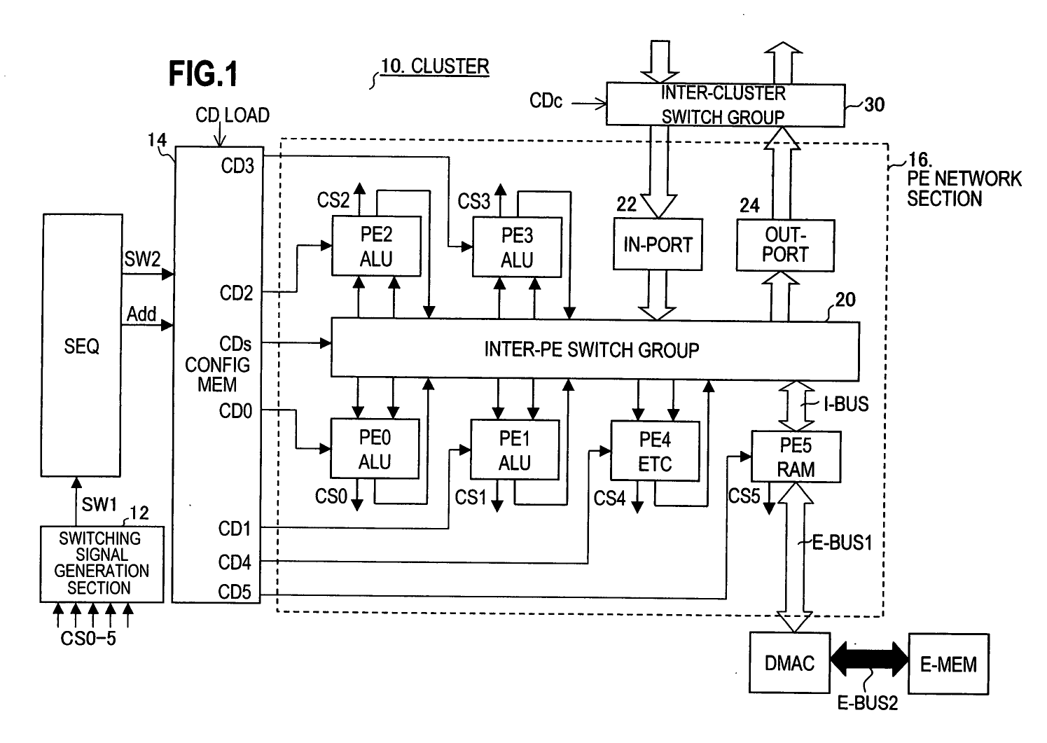

FIG. 1 is a block diagram depicting a cluster constituting a part of the reconfigurable integrated circuit device according to the present embodiment. The cluster 10 comprises a sequencer SEQ for performing status management, a configuration data memory 14 for storing configuration data CD, and a processor element network section 16 to be configured in an arbitrary circuit configuration by the configuration data CD. In the configuration data memory 14, the configuration data CD is loaded from the configuration data load section, which is not illustrated.

The processor element network section 16 comprises a plurality of processor elements (hereafter frequently called PE) PE0-PE5, an inter-PE switch 20 which is a group of such switches as a selector for connecting PEs, and an input port section 22 and output port section 24 as the interfaces for performing data transfer with other clusters. These input and output port section 22 and 24 are connected to the inter-cluster switch group 30. According to the example in FIG. 1, the processor elements PR0-PR3 are all operation PEs, and each has an ALU, adder, comparator internally. The processor element PE4 is another PE, such as a delay circuit or a counter, and the processor element PE5 is a memory PE which has a RAM internally.

To these processor elements PE0-PE5, the configuration data CD0-CD5 is supplied from the configuration data memory 14, and configuration data is stored in the register, which is not illustrated, in these PEs. And based on the configuration data CD0-CD5 which is set in these registers, the circuits in each PE are dynamically configured. In the same way, the configuration data CDs are also supplied from the configuration data memory 14 to the inter-PE switch group 20, and based on this data, a required structure of the internal switch group is configured and the data paths between PEs are dynamically configured. The inter-cluster switch group 30 is also dynamically configured based on the configuration data CDs, and the data paths between clusters are configured.

The memory processor element PE5 in the cluster can perform data transfer with each PE0-PE4 via the inter-PE switch group 20. Therefore the memory processor element PE5 is connected to the internal bus I-BUS. The memory processor element PE5 can perform data transfer directly with the external memory E-MEM via the external bus E-BUS1 and E-BUS2, and this memory access is directly performed via a bus which is different from the inter-cluster switch group 30 by the control of the direct memory access control section DMAC. Therefore the memory processor element PE5 can perform data transfer directly with the external memory E-MEM, and can perform data transfer at a timing independent from the operation of the data paths between the clusters.

Each end signal CS0-CS5 is output respectively from each processor element PE0-PE5, and the switching signal generation section 12 outputs the switching signal SW1 based on these end signals. Responding to this switching signal SW1, the sequencer SEQ outputs a new address Add and the switching signal SW2 to the configuration data memory 14, and responding to this, new configuration data is output, and the circuit configuration in the PE network section 16 is newly configured.

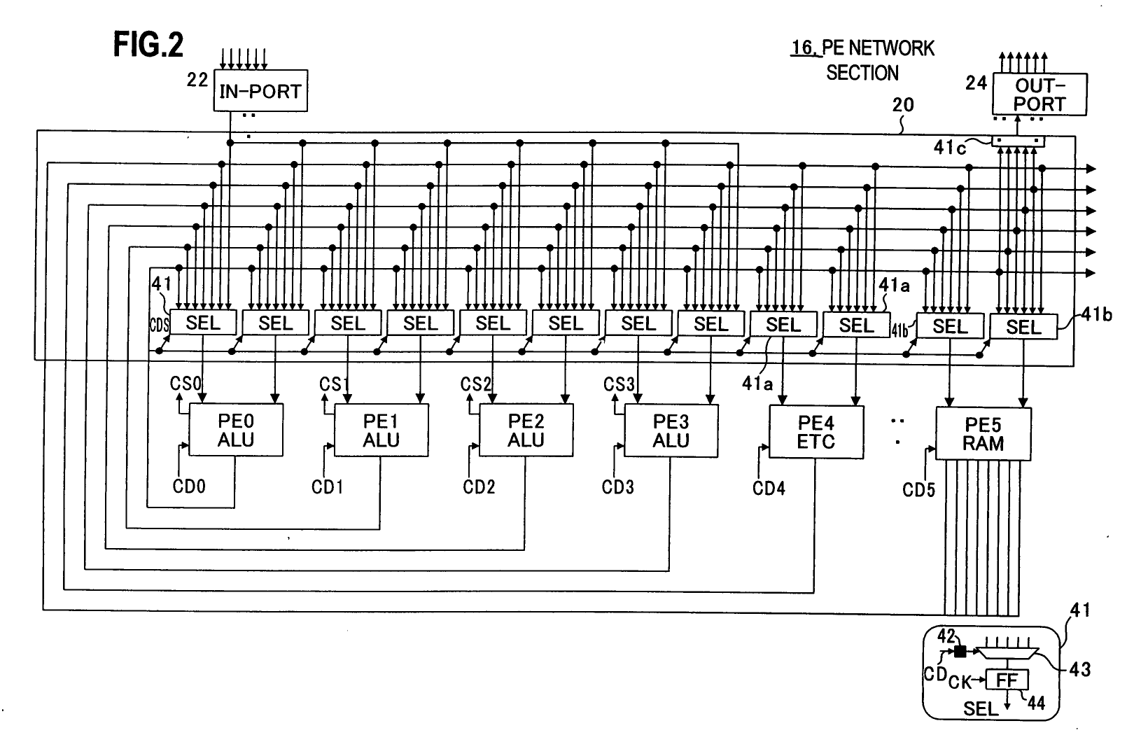

FIG. 2 is a diagram depicting a configuration example of the PE network section according to the present embodiment. The operation processor elements PE0-PE3, memory processor element PE5 and the other processor element PE4 are connectable via the selector 41, which is a switch of the inter-PE switch group 20. In this configuration, each processor element PE0-PE5 can be configured in an arbitrary configuration based on the configuration data CD0-CD5, and the selector 41 (41a, 41b, 41c) of the inter-PE switch group 20 can also be configured in an arbitrary configuration based on the configuration data CDs.

As shown at the lower right in FIG. 2 as an example, the selector 41 comprises the register 42 for storing the configuration data CD, selector circuit 43 for selecting input according to the data of the register 42, and the flip-flop 44 which latches the output of the selector circuit 43 synchronizing with the clock CK.

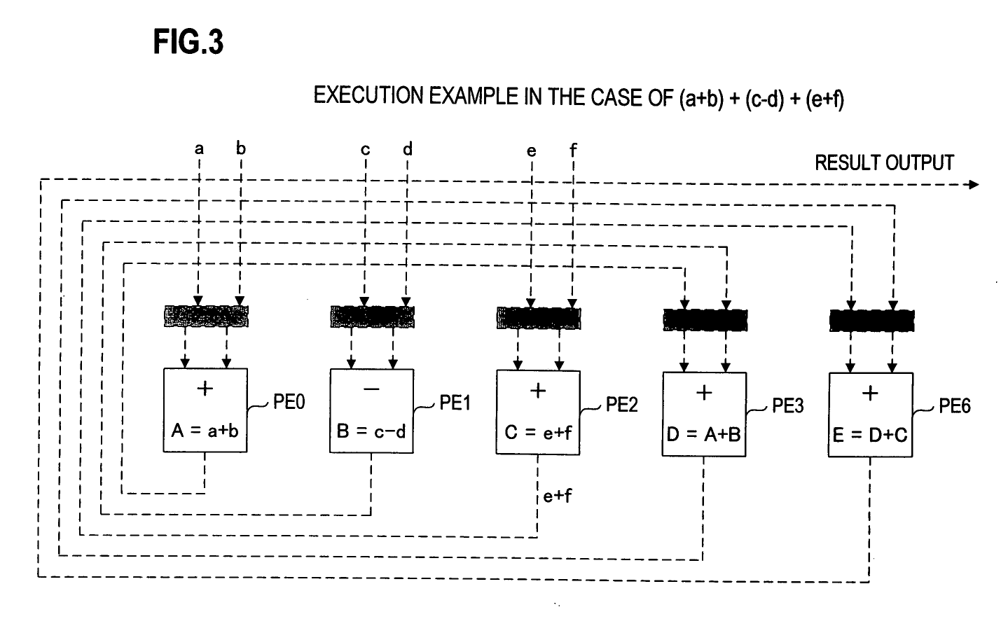

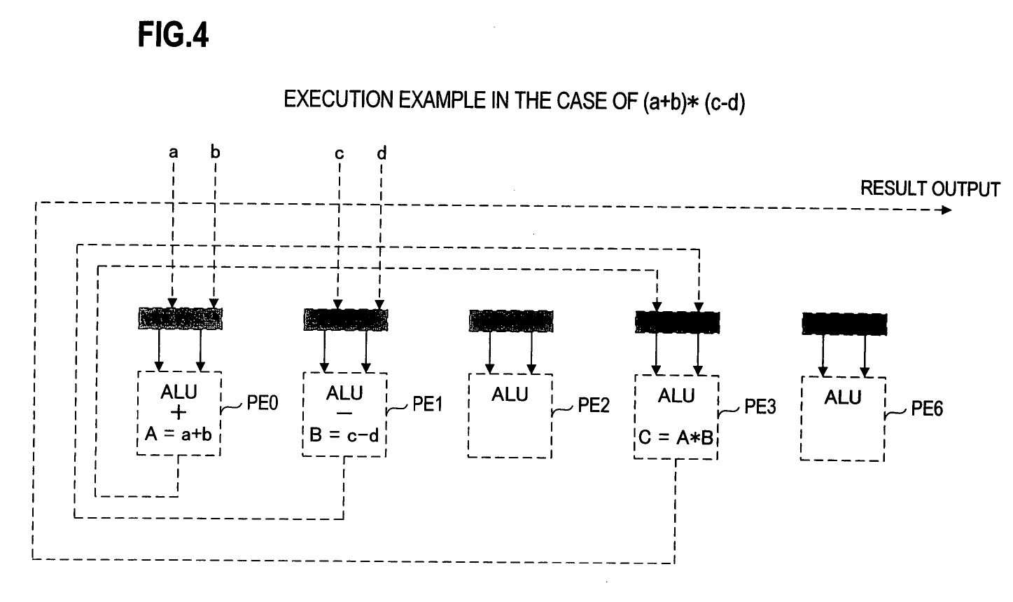

FIG. 3 and FIG. 4 are diagrams depicting the circuit configuration examples configured by the configuration data of the PE network section according to the present embodiment. In FIG. 3 and FIG. 4, the operation processor elements PE0-PE3 and PE6, which can dynamically configure the operation circuit, are connected by the inter-PE switch group 20, and are configured to the dedicated operation circuit which performs a predetermined operation at high-speed. The processor element PE6 is not shown in FIG. 1 and FIG. 2.

The example in FIG. 3 is an example when the dedicated operation circuit for executing the following arithmetic expression for the input data a, b, c, d, e and f is configured.
(a+b)+(c−d)+(e+f)
   According to the examples of this configuration, the processor element PE0 is configured to be the A=a+b operation circuit, the processor element PE1 is configured to be the B=c−d operation circuit, the processor element PE2 is configured to be the C=e+f operation circuit, the processor element PE3 is configured to be the D=A+B operation circuit, and the processor element PE6 is configured to be the E=D+C operation circuit. Each data a−f is supplied from the memory processor element and the external cluster, which are not illustrated, and the output of the processor element PE6 is output to the memory processor element and the external cluster as the operation result E.

The processor elements PE0, PE1 and PE2 perform operation in parallel, the processor element PE3 performs the operation D=A+B for the above operation result, and finally the processor element PE6 performs the operation E=D+C. In this way, parallel operation is enabled by configuring a dedicated operation circuit, which can increase operation processing efficiency.

Each operation processor element has a built-in ALU, adder, multiplier and comparator, and can be reconfigured into an arbitrary operation circuit based on the configuration data CD. By configuring as FIG. 3, a dedicated operation circuit, for performing the above dedicated operation, can be configured. And by configuring such a dedicated operation circuit, a plurality of operations can be executed in parallel, which can increase operation efficiency.

The example in FIG. 4 is an example when a dedicated operation circuit for executing the operation of (a+b)*(c+d) for the input data a−d is configured. The processor element PE0 is configured to be the A=a+b operation circuit, processor element PE1 is configured to be the B=c−d operation circuit, processor element PE3 is configured to be the C=A*B operation circuit, and the operation result C is the output to a memory processor element or an external cluster. In this case as well, the processor elements PE0 and PE1 perform operation in parallel, and the processor element PE3 performs the operation processing C=A*B for the operation results A and B thereof. Therefore by configuring a dedicated operation circuit, the above mentioned operation efficiency can be increased, and the operation efficiency on a large volume of data can be increased.

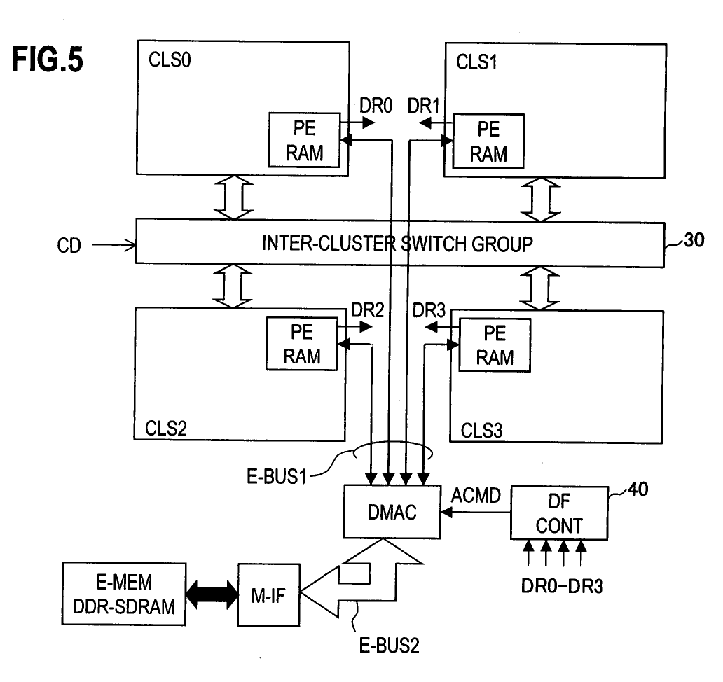

FIG. 5 is a block diagram depicting the reconfigurable integrated circuit device according to the present embodiment. In FIG. 5, a plurality of clusters CLS0-CLS3 are installed, and the inter-cluster switch group 30 for connecting these clusters is disposed in the area between the clusters. By configuring this inter-cluster switch group 30 by the configuration data CD, an arbitrary operation circuit, combining a plurality of clusters, can be dynamically configured.

In the case of the example of FIG. 5, the memory processor element PE-RAM is installed in each cluster CLS0-CLS3. In a cluster, a plurality of memory processor elements may be installed, or no memory processor element may be installed depending on the case. These memory PEs are connected to the direct memory access control section DMAC via the external bus E-BUS1, and perform data transfer with the external memory E-MEM by direct memory access via the access control section DMAC. For this external memory E-MEM, a DDR-SDRAM (Double Data Rate Synchronous DRAM), for example, is used as an example of high-speed memory. Also a common data flow control section 40 is installed for the plurality of memory processor elements PE-RAM. Each memory processor element issues an access request DR0-DR3, and responding to this access request, the data flow control section 40 sends an access command to the control section DMAC, so as to execute data transfer by DMA with the memory processor element which sent the access request.

The data flow control section 40 accepts the access request from the plurality of memory processor elements, and synchronously executes the DMA data transfer between this plurality of memory processor elements and the external memory. In other words, the access control section DMAC sequentially executes DMA data transfer with the plurality of memory processor elements synchronously by round-robin based on the access command ACMD from the data flow control section 40.

In this way, the memory processor element in the cluster DMA-transfers the data, which will be processed by the operation circuit configured by the operation processor element in the cluster, from the external memory E-MEM, and DMA-transfers the processed data to the external memory E-MEM. This DMA-transfer is directly performed by the external buses E-BUS1 and E-BUS2, which are separate from the inter-cluster switch group 30 for connecting the clusters. Therefore in the case of the reconfigurable integrated circuit device, data transfer can be performed between each memory processor element and the external memory via a path which is separate from the inter-cluster switch group 30 at a timing required by each memory processor element, even if the connection structure of the inter-cluster switch group 30 is dynamically changed, and an optimum data transfer for a dynamically configured cluster or for a plurality of clusters can be implemented.

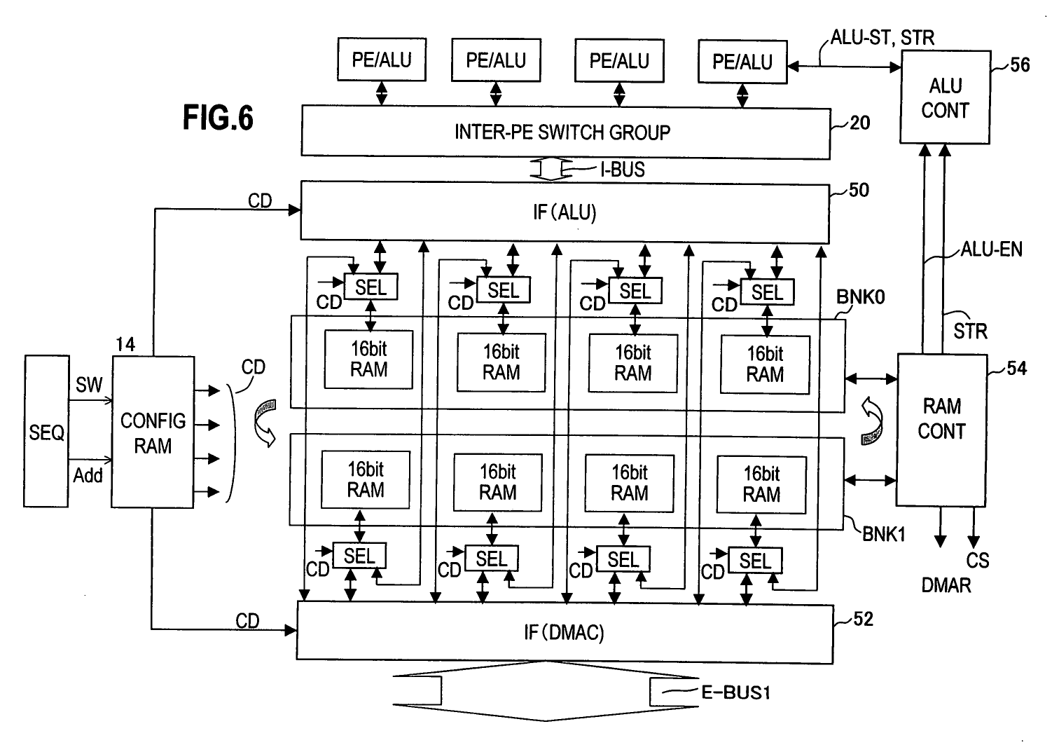

FIG. 6 is a block diagram depicting an example of the memory processor element according to the present embodiment. To enable a seamless data transfer between the external memory and the operation processor elements in the cluster, the memory processor element comprises a first memory bank BNK0 and a second memory bank BNK1, and further comprises an internal side interface 50 between these memory banks and an inter-PE switch group 20, and an external side interface 52 between these memory banks and an external bus E-BUS1. Each memory bank BNK0 and BNK1 further comprises four 16-bit width RAMs respectively. The internal side interface 50 is connected to the internal bus I-BUS, which is connected to the inter-PE switches 20, and is dynamically configured to be a different input/output bus interface structure based on the configuration data CD. The external side interface 52 is connected to the external bus E-BUS1, and is also dynamically configured to be the input/output bus interface structure based on the configuration data CD. Details on the input/output bus interface structure to be configured will be described later.

In the first and second memory banks BNK0 and BNK1, while one memory bank is performing data transfer with the internal operation processor element PE/ALU, the other performs data transfer with the external memory E-MEM, and both of the memory banks can also perform data transfer alternately. For this, the selectors SEL are installed between both the memory banks BNK0 and BNK1 and the internal side and the external side interfaces 50 and 52, and these selectors SEL are set according to the configuration data CD. By this, the first and second memory banks can be alternately connected to the internal side and the external side interfaces. The signal lines between the interfaces 50 and 52 and each memory bank BNK0 and BNK1 include a 16-bit data line, address line and all the other necessary control lines.

The memory processor element internally comprises a memory control section 54 for controlling the switching of the memory banks and controlling DMA requests, and an operation control section 56 for performing operation execution control for the internal operation processor element PE/ALU. The memory control section 54 monitors the status of the memory banks and performs switching control of the memory banks, DMA requests, and the asserting and negating of the stall signal STR for stopping the operation of the operation processor element, so as to enable seamless data transfer between the external memory and the internal operation processor element. Responding to this stall signal STR, the operation control section 56 controls the start and stop of the operation of the operation processor element.

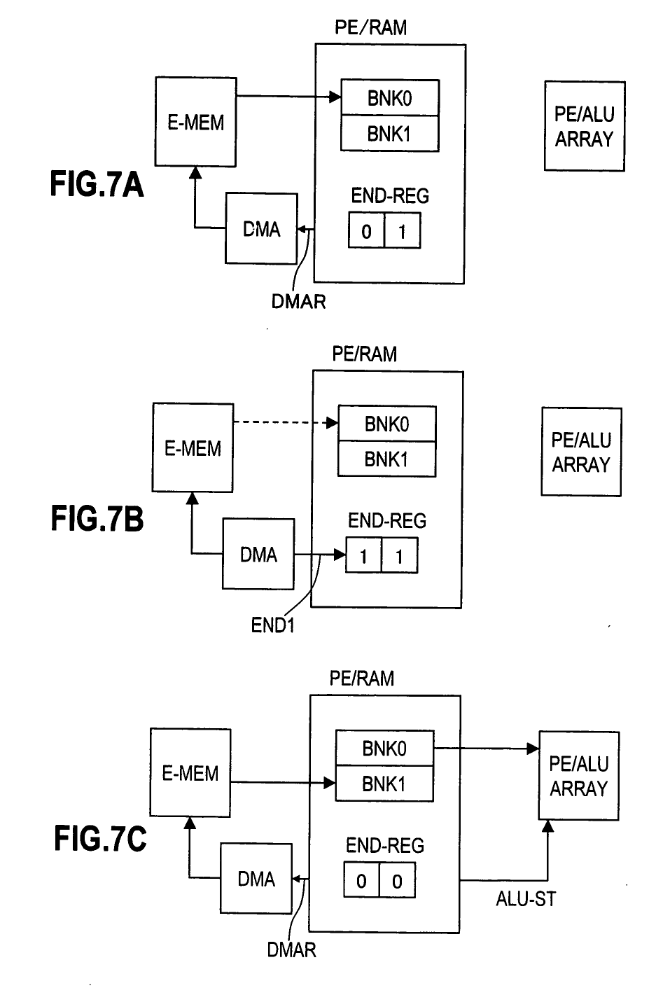

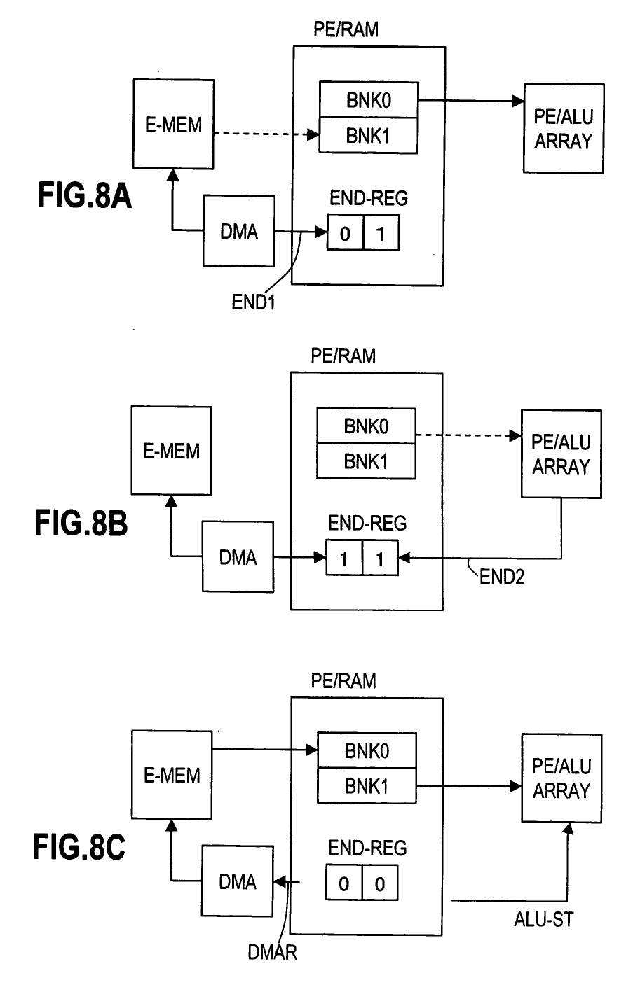

FIG. 7 and FIG. 8 are diagrams depicting the switching operations of the two memory banks in the memory processor element of the present embodiment. In FIG. 7 and FIG. 8, two memory banks BNK0 and BNK1 and access end registers END-REG, which the memory control section 54 (see FIG. 6) uses for controlling the switching of the memory banks, are shown in the memory processor element PE/RAM. There are two access end registers END-REG, where a flag to indicate the access status of the first and second memory bank is stored respectively, and is set to end status “0” when memory access ends and the end signal is received, for example, and is set to ready status “1” when a memory bank enters access enable status (ready). And by monitoring these two register values, the memory control section 54 (see FIG. 6) controls the switching of the two memory banks BNK0 and BNK1.

Now the operation after initial startup will be described with reference to FIG. 6, FIG. 7 and FIG. 8. At startup, the sequencer SEQ outputs the address corresponding to the initial startup after reset is cleared, and configuration data for initial startup is output from the configuration data memory 14 (FIG. 6), and the processor elements PE in the clusters and the inter-PE switch group 20 are configured to be the initial circuit configuration. By this initial startup, an initial value is set in the access end register END-REG as shown in FIG. 7A. In this example, the register of the first memory bank BNK0 is in ready status (flag is “0”), and the register of the second bank memory BNK1 is in access end status (flag is “1”). By this initial startup, the selectors SEL are configured such that the first memory bank BNK0 is connected to the external side interface 52, and the second memory bank BNK1 is connected to the internal side interface 50.

After initial startup, the memory control section 54 refers to the access end register and outputs the access request DMAR for the external memory. As mentioned above, the access request DMAR is sent to the direct memory access control section DMAC via the data flow control section 40 (FIG. 5), and direct data transfer is started between the external memory E-MEM and the first memory bank BNK0. Specifically the data read from the external memory E-MEM is directly transferred and written to the first memory bank BNK0 via the external bus. The access request DMAR at initial startup is output from the plurality of memory processor elements, as mentioned above, so data transfer by a plurality of direct memory accesses is synchronously executed.

Then as FIG. 7B shows, when data transfer from the external memory E-MEM to the first memory bank BNK0 ends, the access end signal END1 is sent from the DMA control section DMAC, and responding to this, the bit corresponding to. the first memory bank of the access end register END-REG becomes access end status (flag “1”). In this way, when both registers become access end status (flag “1”), the memory control section 54 issues the status end signal CS, has the sequencer SEQ output the next address Add and has the configuration data memory 14 output a new configuration data CD, so as to switch the first and second memory banks BNK0 and BNK1. In other words, the second memory bank BNK1 is connected to the external side interface 52 and the first memory bank BNK0 is connected to the internal side interface 50.

Then as FIG. 7C shows, when two memory banks are switched, the memory control section 54 clears the access end register END-REG, so as to set both memory banks to ready status (flag “0”). Responding to this status, the memory control section 54 outputs the access request DMAR to the external memory, and based on this access request, the DMA control section DMAC controls data transfer between the external memory E-MEM and the second memory bank BNK1. The access control DMAR in this case is issued at a timing of the memory processor element of which access is required, unlike the time of initial startup, so that data transfer is executed on demand. At the same time, the memory control section 54 outputs a signal ALU-EN which indicates that an internal operation processor element can be executed, and responding to this, the operation control section 56 outputs the operation start signal ALU-ST to the internal operation processor element PE/ALU, and starts the operation processing of the operation processor element. By this, the internal operation processor element PE/ALU accesses the first memory bank BNK0, reads the data, and executes operation processing on the read data.

Then as FIG. 8A shows, when the data transfer between the second memory bank BNK1 and the external memory E-MEM ends, the access end register END-REG is set to the access end status (flag “1”) responding to the access end signal END1. Normally the direct memory access with the external memory has a wide data bus width and is therefore a high-speed data transfer, and ends before the data transfer with the internal operation processor element.

And as FIG. 8B shows, the access from the internal operation processor element PE/ALU also ends, and the remaining flag of the access end register END-REG is also set to the access end status (flag “1”) by the access end signal END2. Responding to this, the memory control section 54 outputs the status end signal CS, and replaces the connection with the internal side and the external side interfaces of the first and second memory banks BNK0 and BNK1 by the configuration data CD which is output from the configuration data memory 14.

And as FIG. 8C shows, the memory control section 54 outputs the direct memory access request DMAR again, starts data transfer between the first memory bank BNK0 and the external memory E-MEM, and the operation control section 56 outputs the operation start signal ALU-ST and starts access from the internal operation processor element PE/ALU to the second memory bank BNK1.

As described above, the memory control section 54 enables seamless data transfer from the external memory E-MEM to the internal operation processor element by alternately switching the first and second memory banks. In particular the direct memory access with the external memory is faster than access by an internal operation processor element, so the operation processor element can read and process data seamlessly.

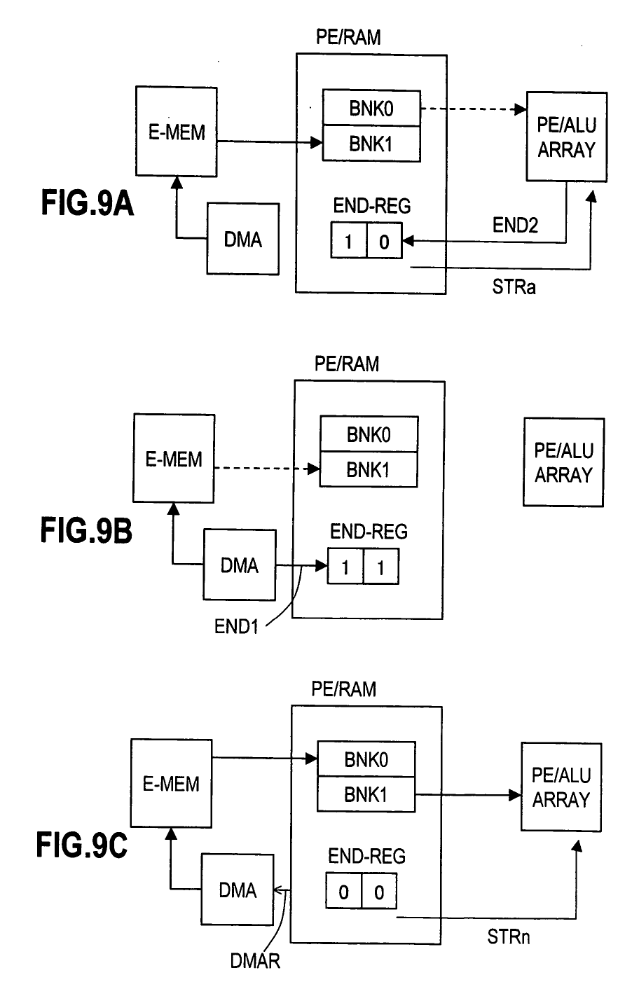

FIG. 9 are diagrams depicting the switching operation of the two memory banks in the memory processor element according to the present embodiment. Here control, when a problem occurred to the seamless data transfer, will be described. Since the direct data transfer with the external memory is performed at high-speed, normally one memory bank ends the data transfer with the external memory before the other memory bank ends the data transfer with the internal operation PE. And memory bank switching control is performed when the data transfer with the internal operation PE completes, and by this, the seamless data transfer between the external memory and the internal operation PE becomes possible. But for some reason there is a case when data transfer with the internal operation PE completes first.

As FIG. 9A shows, if the data transfer from the first memory bank BNK0 to the internal operation PE ends first, the access end register END-REG is set to the access end status (flag “1”) by the end signal END2. Responding to this, the memory control section 54 asserts the stall signal STR to the operation control section 56, and by this the operation PE array temporarily stops the pipe-line processing thereof. In other words, when data cannot be read from the memory PE, the pipe-line processing of the operation PE array cannot be performed, and operation processing begins to have problems.

And as FIG. 9B shows, when the data transfer of the second memory BNK1 completes, the access end register END-REG is set to the access end status by the end signal END1. As a result, the memory control section 54 outputs the status end signal CS, and switches the memory banks by the configuration data CD. Then as FIG. 9C shows, the memory control section 54 outputs the access request DMAR, has the first memory bank BNK0 start data transfer with the external memory, negates the stall signal STR, and restarts the operation of the internal operation PE array, and as a result, the second memory bank BNK1 starts data transfer with the internal operation PE.

In this way, a dedicated operation circuit is configured and the data operation processing is pipe-line-processed, so when the memory control section 54 monitors the access status of the two memory banks and seamless transfer of data is disabled, the memory control section 54 asserts the stall signal STR to stop the pipe-line processing to the internal operation PE. By this, the problems which may occur to the pipe-line processing can be prevented. And when seamless transfer is enabled, the memory control section 54 negates the stall signal STR, and restarts the pipe-line processing.

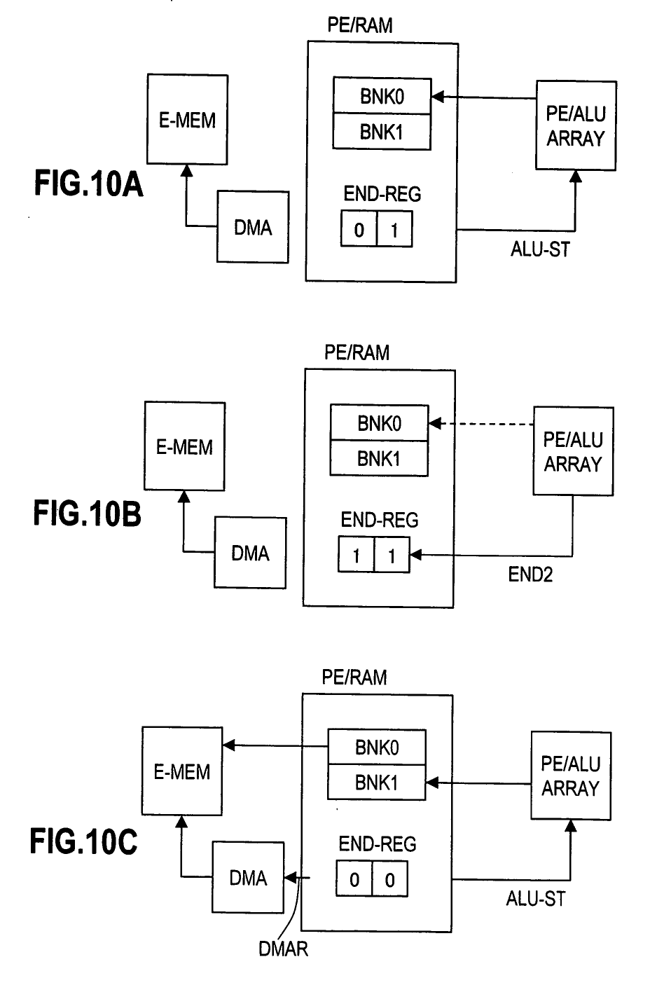

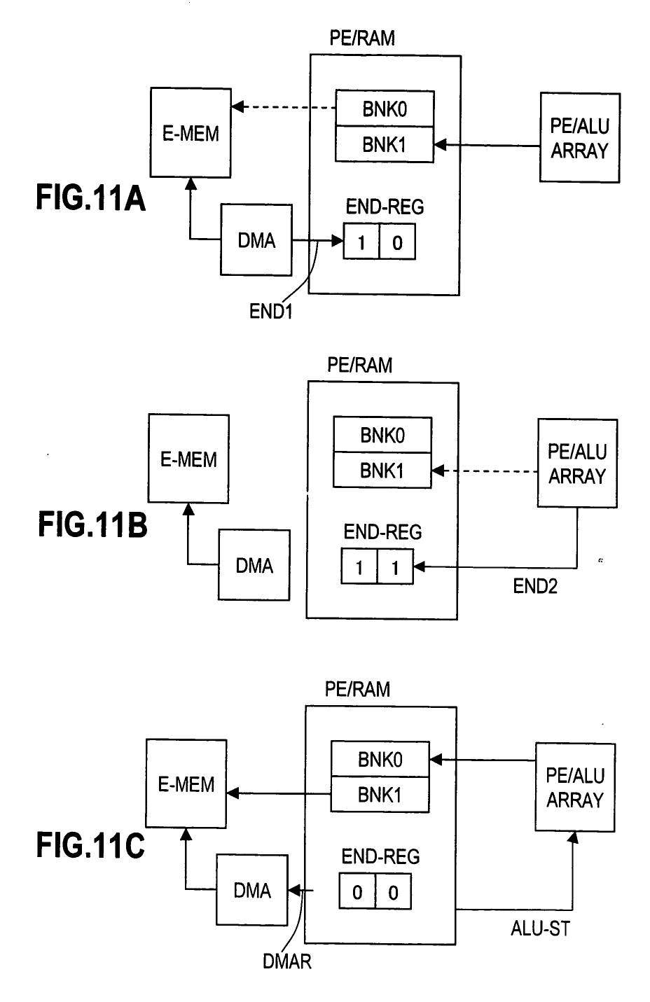

FIG. 10 and FIG. 11 are diagrams depicting the switching operation of the two memory banks in the memory processor element. This is an example when data transfer is performed from the internal operation PE to the external memory E-MEM via the memory PE.

In FIG. 10A, the operation PE writes data to the first memory bank BNK0. In FIG. 10B, when data write completes, both the access end registers END-REG become access end status (flag “1”). Responding to this, the memory control section 54 outputs the status end signal CS, and switches the two memory banks based on the configuration data CD. And as FIG. 10C shows, the first memory bank BNK0 starts direct data transfer with the external memory by the access request DMAC and data write from the operation PE to the second memory bank BNK1 by the operation start signal ALU-ST to the operation PE.

Then as shown in FIG. 11A, data transfer of the first memory bank BNK0 completes first, and data write from the operation PE ends as in FIG. 11 B. So the memory control section 54 switches the two memory banks, and the data transfer of the memory bank switched as in FIG. 11C starts respectively.

As described above, data transfer from the operation PE to the external memory is also performed seamlessly via the memory PE. If the seamless data transfer is disabled mid-way, the stall signal STR is negated, the operation PE array stops pipe-line processing, and restarts the pipe-line processing when data transfer is enabled.

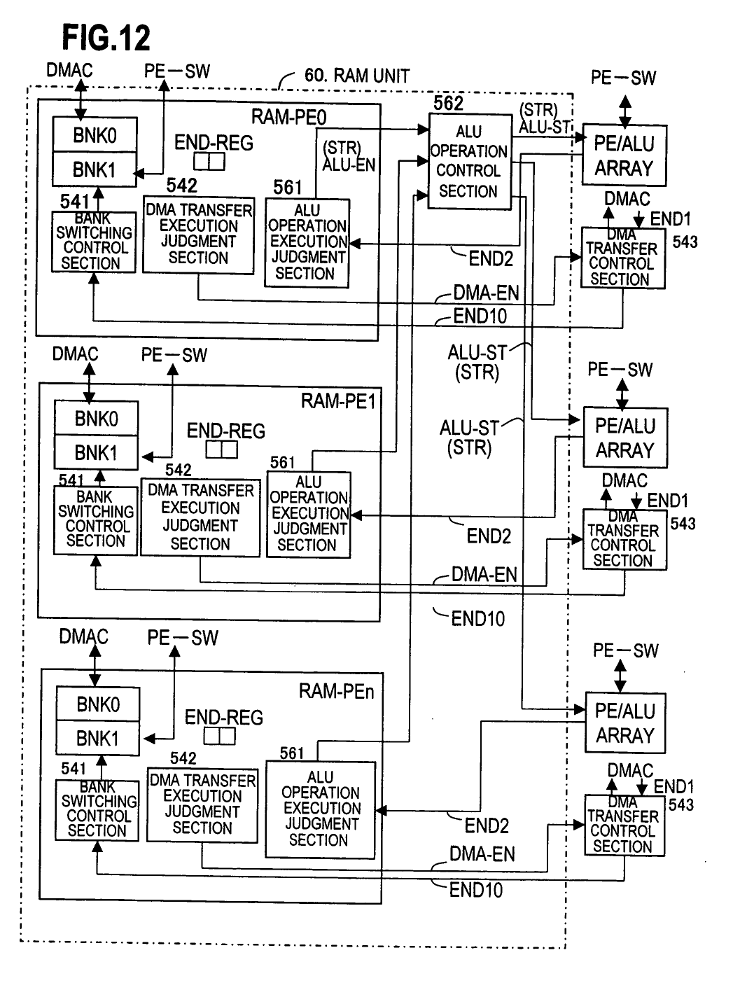

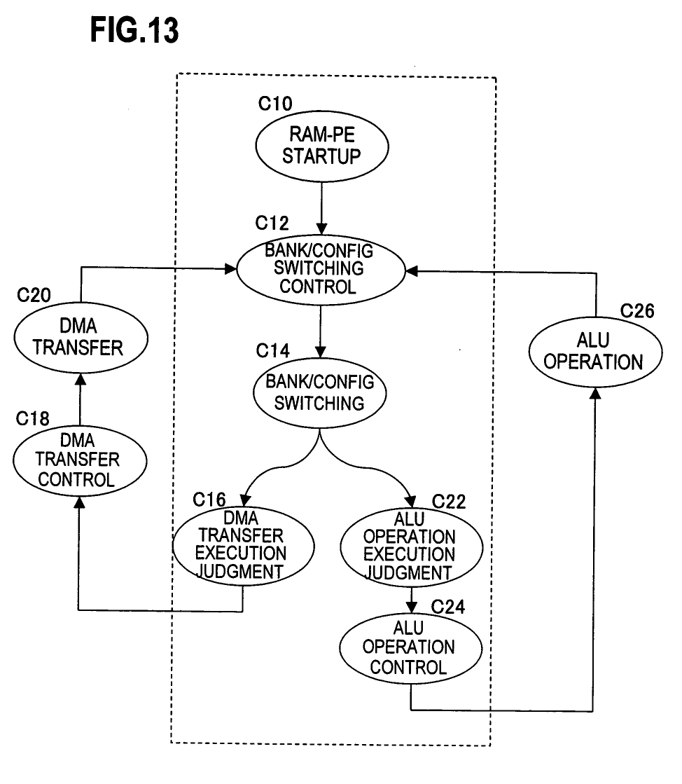

FIG. 12 is a block diagram depicting the control section of the memory processor element according to the present embodiment. FIG. 13 is a status transition diagram of the control section thereof. In the example in FIG. 12, the memory unit 60 in a same cluster has a plurality of memory processor elements RAM-PE0-PEn, and the array PE/ALU-ARRAY of the operation processor element is configured corresponding to each of the memory processor elements RAM-PE0-PEn. Each memory PE encloses the bank switching control section 541 and the DMA transfer execution judgment section 542 as the memory control section 54, and also has the ALU operation execution judgment section 561 as the operation control section 56. The plurality of memory PEs share the ALU operation control section 562 as the operation control section 56, and the DMA transfer control section 543 is provided as the memory control section 54. The first and second memory banks BNK0 and BNK1 in the memory PE are configured so as to alternately perform data transfer with the access control section DMAC via the external bus and with the operation processor element array PE/ALU-ARRAY via the inter-PE switch group PE-SW in the cluster.

The control flow will be described with reference to the status transition diagram in FIG. 13. As mentioned above, first the memory processor element RAM-PE starts up and is configured to be a desired circuit configuration based on the configuration data CD (C10). By this startup, the access end register END-REG is set to the flag of the initial value, and the memory bank becomes initial status by this flag status (C12).

During operation after the memory processor element RAM-PE is started up, the bank switching control section 541 controls the switching of the memory banks by the status of the access end register END-REG (both flags “1”) (C12), and the memory banks are switched by this (C14). When the memory banks are switched, the circuit configuration of the operation PE may be switched accordingly (C12, C14).

When the memory banks are switched, the DMA transfer execution judgment section 542 judges whether data transfer to the external memory is possible or not, and if data transfer can be executed, the DMA transfer execution judgment section 542 outputs the DMA transfer enable signal DMA-EN to the DMA transfer control section 543 which is installed outside the memory PE (C16). Whether data transfer can be executed or not depends on the status of the access end register END-REG to indicating the status of the memory bank. And the corresponding DMA transfer control section 543 outputs the access request to the access control section DMAC via the data flow control section 40 (not illustrated but see FIG. 5) (C18), and data transfer is executed (C20). And when the data transfer with the external memory ends, the DMA transfer control section 543 receives the data transfer end signal END1, and the data transfer end signal END10 is sent to the bank switching control section 541. Then the above mentioned bank switching control is performed according to the status of the access end register END-REG(C12).

On the other hand, when the memory banks are switched, the ALU operation judgment section 561 monitors the status of the memory bank based on the access end register END-REG, and judges whether access from the operation PE is possible or not, that is, whether the operation PE can execute the operation processing or not (C22). If execution is possible, the ALU operation execution judgment section 561 outputs the operation execution enable signal ALU-EN.

Only when the operation execution enable signal ALU-EN is received from all the memory processor elements RAM-PE0-PEn, the ALU operation control section 562 outputs the operation start signal ALU-ST to all the operation PE arrays in the cluster (C24), and has all the operation PE arrays execute the operation processing synchronously (C26). In other words, the plurality of operation PE arrays in the cluster must perform pipe-line processing synchronously while performing data transfer with a plurality of memory PEs, so one ALU operation control section 562 is installed as a common for the plurality of memory PEs, and only when the operation execution enable signal ALU-EN is received from all the memory PEs, the common ALU operation control section 562 outputs the operation start signal ALU-ST to the plurality of operation PE arrays. The ALU operation execution judgment section 561 monitors the status of the memory bank, and if data transfer cannot be performed seamlessly, the ALU operation execution judgment section 561 asserts the stall signal STR, and stops the pipe-line processing of the operation PE array. This stall signal STR is as described above.

When the operation processing completes, access to the memory bank at the operation PE side ends, so the end signal END2 is received from the operation PE, and the ALU operation execution judgment section 561 negates the operation execution enable signal ALU-EN. By this end signal END2, the flag status of the access end register END-REG is changed, and the memory banks are switched or the configuration change of the operation PE is controlled and executed accordingly (C12, C14).

In FIG. 13, the status transition within the broken line shows the status transition of the memory PE, the left side thereof shows the status of the DMA transfer control section 543 and the direct memory access control section DMAC, and the right side thereof shows the status of the ALU operation control section 562 and the operation PE array.

In FIG. 12 and FIG. 13, the DMA transfer control section 543 outputs the DMA request based on the DMA transfer enable signal DMA-EN which is output by the DMA transfer execution judgment section 542, but the DMA transfer control section 543 may check the status of the channel accepted by the direct memory access control section DMAC, so as to judge whether DMA transfer can be executed or not, that is whether the DMA transfer execution timing is appropriate or not, and output the DMA request if appropriate. By this, when the number of channels of the direct memory access control section DMAC exceeds a predetermined number and the timing is not appropriate for sending the DMA request, sending of the DMA request can be stopped until the number of channels becomes a predetermined number or less, and DMA transfer timing can be delayed. The DMA transfer enable signal DMA-EN is generated by the status of the access end register END-REG, so this control of delaying the DMA transfer timing is significant.

In FIG. 13, when the operation by the operation processor element array ends (C26), new configuration data is output from the sequencer, and the configuration data of the operation PE is changed (C12). The configuration data is switched when necessary.

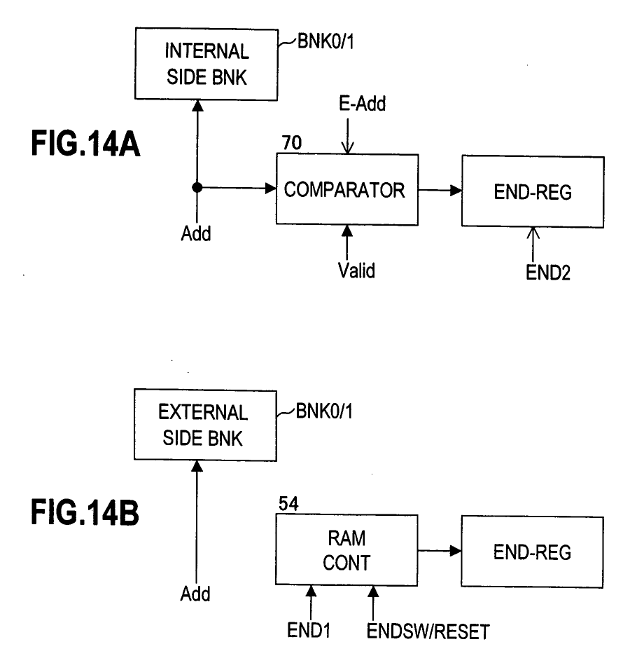

FIG. 14 are diagrams depicting the flag change control of the access end register. FIG. 14A shows the flag change control when the memory bank BNK 0/1 is connected to the internal side (operation PE array side). Address Add for access is supplied to the memory bank BNK from the operation PE array side, and corresponding access is performed. This access address Add is also supplied to the comparator 70 in the memory control section 54. And the end address E-Add to be accessed when the circuit is configured based on the configuration data has been set in the comparator 70 in advance. Each time the address valid signal Valid, to indicate whether the address attached to the access address is valid or not, becomes valid, the comparator 70 compares the access address Add and the end address E-Add, and changes the flag of the access end register END-REG to “1” if they match.

As another control method, the flag of the access end register END-REG may be changed to the end status “1”, responding to the end signal END2 from the operation PE array. In any case, the flag of the access end register END-REG is set to ready status “0” when the internal side and the external side memory banks are switched.

FIG. 14B shows the flag change control when the memory bank BNK 0/1 is connected to the external side (external memory E-MEM side). In this case, the access address Add is supplied from the access control section DMAC. And responding to the end signal END1 from the access control section DMAC, the memory control section 54 changes the flag of the access end register END-REG to the end status “1”, and when the internal side and the external side of the memory banks are switched, the memory control section 54 sets the flag of the access end register END-REG to ready status “0” responding to the switching end signal END-SW.

Also the end status of the access end register END-REG is cleared by reset and set to ready status.

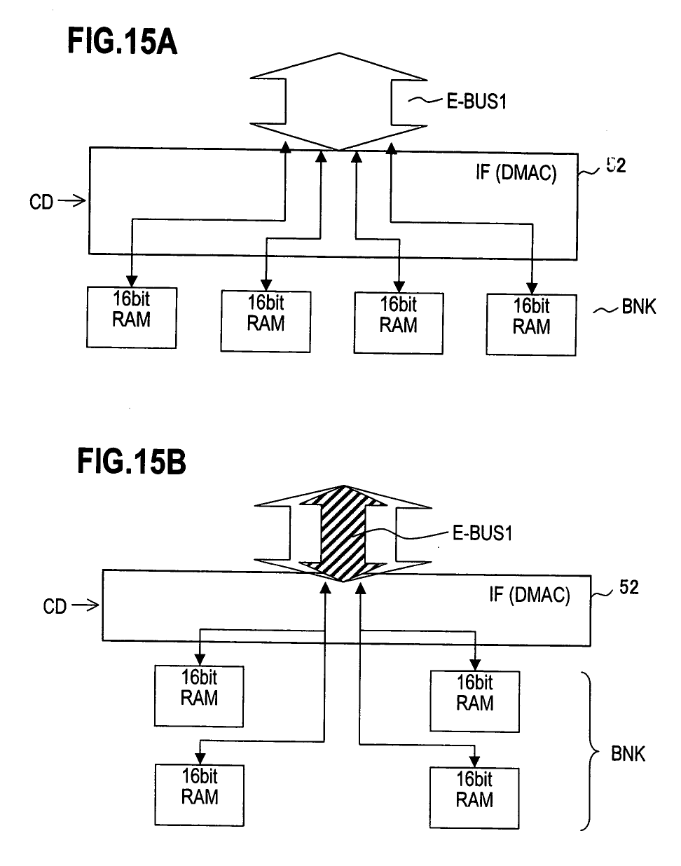

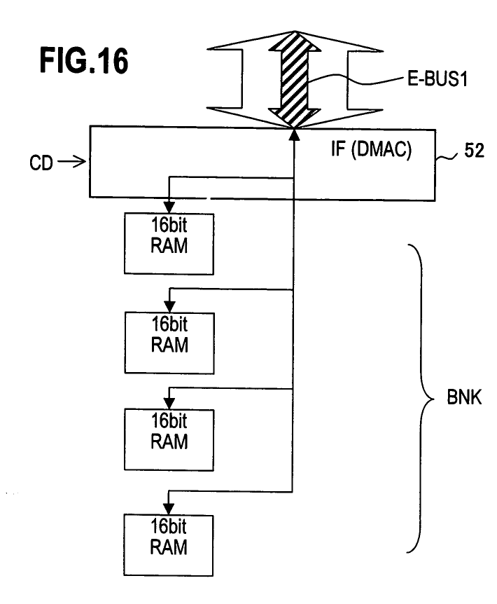

FIG. 15 and FIG. 16 are diagrams depicting the external side interface in the memory PE. The external side interface 52 is connected to the external bus E-BUS1, and is dynamically configured to be a different input/output bus interface structure based on the configuration data CD. Normally the external bus E-BUS1 used for direct memory access has a width bus width. For example, in the case when the external memory E-MEM is a 32-bit DDR-SDRAM, data is output twice in a one clock cycle, so the bus width of the external bus E-BUS1 is 64 bits. In this case, the circuit of the external side interface 52 is configured such that 64-bit data is input to/output from the four 16-bit RAMs in the memory bank BNK in parallel.

FIG. 15A shows the external side interface when the bus width of the external bus E-BUS1 is 64 bits. AS mentioned above, 64-bit data is input to/output from the four 16-bit RAMs in parallel.

FIG. 15B shows the case when the bus width is 32 bits, and the interface is configured such that 32-bit data is input to/output from the two sets of RAMs, each set is comprised of two 16-bit RAMs, in parallel. And the interface inputs/outputs 16-bit data to/from the two RAMs in each set in serial.

FIG. 16 shows the case when the bus width is 16 bits, and the interface is configured such that 16-bit data is input to/output from the four 16-bit RAMs in serial. The configuration of the interface 52 in FIG. 16 is the same as the configuration of the internal side interface. In other words, the internal side interface is configured to be the configuration described in FIG. 16, since the bus width of the internal bus at the operation PE array side is narrow, that is 16 bits. Therefore the internal side interface 50 is configured such that the 16-bit data is input to/output from the four 16-bit RAMs in serial.

In this way the interfaces 50 and 52 in the memory PE are configured so as to match the configuration of the bus, which is connected based on the configuration data CD.

As described above, according to the present embodiment, a plurality of sets of clusters comprising a plurality of operation PEs and memory PEs are disposed in an integrated circuit device which can be configured by dynamically changing the circuit configuration, the clusters are inter-connected by a switch group of which connection status is dynamically changed, and separately from this inter-cluster switch group, the memory PE in the cluster is connected with the external memory. And the memory PE can perform DMA transfer with the external memory. The memory PE is also in a double-buffer configuration, for example, so that seamless data transfer can be performed between the external memory and the operation PE, and if data transfer has problems, the pipe-line operation of the operation PE array temporarily stops.

What is claimed is:

1. A reconfigurable integrated circuit device which is dynamically configured to be in arbitrary operation status based on a configuration data, comprising:
a plurality of clusters further including a plurality of operation processor elements having a computing unit respectively, a memory processor element having a memory to perform data transfer with an external memory, and an inter-processor element switch group for connecting the operation processor elements and the memory processor element in an arbitrary status;
an inter-cluster switch group for configuring data paths between the clusters in an arbitrary status; and
an external memory bus for performing data transfer between the memory processor element and the external memory, wherein
the operation processor elements, the memory processor element, the inter-processor element switch group and the inter-cluster switch group are dynamically changed based on the configuration data, and the device further comprising:
a direct memory access control section for executing data transfer between the memory processor element and the external memory by direct memory access responding to an access request from the memory processor elements of the plurality of clusters.

2. The reconfigurable integrated circuit device according to claim 1, wherein the cluster further comprises a configuration data memory for storing the configuration data, and a sequencer for outputting configuration data to configure the next operation status from the configuration data memory responding to an end signal from the operation processor element and memory processor element.

3. The reconfigurable integrated circuit device according to claim 1, further comprising a data flow control section which is installed as a common for the plurality of memory processor elements for accepting direct memory access requests from the plurality of memory processor elements, and instructing synchronized direct memory access requests to the direct memory access control section for the plurality of memory processor elements.

4. The reconfigurable integrated circuit device according to claim 1, further comprising a data flow control section which is installed as a common for the plurality of memory processor elements for accepting a direct memory access request from the plurality of memory processor elements and instructing synchronized direct memory access requests to the direct memory access control section for the plurality of memory processor elements, wherein
when a direct memory access request is accepted from a single memory processor element, the data flow control section instructs the direct memory access request to the direct memory access control section responding to the acceptance.

5. The reconfigurable integrated circuit device according to claim 1, wherein
the memory processor element further comprises an internal side interface with an internal bus which is connected to the inter-processor element switch group, and an external interface with the external memory bus, and wherein
the operation processor element accesses the memory processor element via the internal side interface while the memory processor element is accessing the external memory, by direct memory access, via the external side interface.

6. The reconfigurable integrated circuit device according to claim 5, wherein
the memory processor element further comprises first and second memory banks, and wherein
the first and second memory banks are alternately connected to the internal side and external side interfaces based on the configuration data.

7. The reconfigurable integrated circuit device according to claim 6, wherein
the memory processor element allows for data transfer between the operation processor element and the first or second memory bank after data transfer between the external memory and the first or second bank completes, and
if the data transfer between the external memory and the first or second memory banks does not complete, the memory processor element asserts a stall signal to instruct to stop operation to the plurality of operation processor elements, and negates the stall signal when data transfer between the external memory and the first or second memory bank completes.

8. The reconfigurable integrated circuit device according to claim 3, wherein the memory processor element monitors the operation status of the direct memory access control section, and supplies the access request to the data flow control section based on the operation status.

9. The reconfigurable integrated circuit device according to claim 8, wherein the memory processor element variably controls the timing of the access request based on the operation status.

10. The reconfigurable integrated circuit device according to claim 1, wherein the memory processor element accepts data transfer with the operation processor element while performing data transfer with the external memory by direct memory access, asserts a stall signal to stop the operation of the plurality of operation processor elements when the data transfer by the direct memory access cannot follow up the data transfer with the operation processor element, and negates the stall signal when follow up is possible.

11. The reconfigurable integrated circuit device according to claim 5, wherein the external interface of the memory processor element is constructed in an interface status corresponding to the plurality of data bus widths based on the configuration data.

12. The reconfigurable integrated circuit device according to claim 1, wherein
the memory processor element further comprises first and second memory banks, and
the memory processor element sets one of the first and second memory banks to a status for enabling access to the external bus side at startup based on the configuration data, and outputting the access request.

13. The reconfigurable integrated circuit device according to claim 12, wherein the memory processor element asserts an operation execution enable signal to the operation processor element when one of the first and second memory banks completes the data transfer by the direct memory access, to prompt the operation processor element to execute operation.

14. The reconfigurable integrated circuit device according to claim 13, wherein the memory processor element asserts a stall signal to request an operation stop of the operation processor element when both of the first and second memory banks enter data transfer disable status.

15. The reconfigurable integrated circuit device according to claim 13, wherein the cluster further comprises a plurality of memory processor elements and comprises an operation execution control section in common with the memory processor elements for requesting synchronized operation execution to the plurality of operation processor elements responding to the assert of an operation execution enable signal from the plurality of memory processor elements.

16. A reconfigurable integrated circuit device which is dynamically configured to be a predetermined operation status based on a configuration data, comprising:
a plurality of clusters including an operation processor element having a computing unit, a memory processor element having a memory to perform data transfer with an external memory, and an inter-processor element switch group for connecting the operation processor element and the memory processor element in an arbitrary status;
an inter-cluster switch group for configuring data paths between the clusters in an arbitrary status; and
an external memory bus for performing data transfer between the memory processor element and the external memory, wherein
the operation processor element, the memory processor element, the inter-processor element switch group and the inter-cluster switch group are dynamically changed based on the configuration data, and the device further comprising:
a direct memory access control section for executing data transfer between the memory processor element and external memory by direct memory access responding to the access requests from the memory processor elements of the plurality of clusters, wherein
the memory processor element includes first and second memory banks, wherein while one of the first and second memory banks is performing data transfer with the external memory by direct memory access, the other of the first and second memory banks performs data transfer with the operation processor element.
